(19) United States
(12) Patent Application Publication
(10) Pub. No.: US 2012/0259496 A1
(43) Pub. Date: Oct. 11, 2012

(54) HYBRID VEHICLE

(75) Inventor: Takefumi Ikegami, Saitama (JP)

(73) Assignee: HONDA MOTOR CO., LTD, Tokyo (JP)

(21) Appl. No.: 13/518,633

(22) PCT Filed: Oct. 12, 2010
(86) PCT No.: PCT/JP2010/067890

§ 371 Date: Jun. 22, 2012

(30) Foreign Application Priority Data
Dec. 24, 2009 (JP) 2009293196

(51) Int. Cl. B60W 20/00

(52) U.S. Cl. 701/22; 180/65.285; 903/902

(57) ABSTRACT

ECU controls an electric motor, in the state where the connection between an engine and the electric motor is disconnected and the engine is stopped, to be a creep speed corresponding to a creep rotational speed set larger than a rotational speed capable of starting the engine by a predetermined rotational speed. Further, ECU controls to start the engine by the motive power of the electric motor by connecting the engine and the electric motor, if an engine starting condition is satisfied and at the rotational speed of the electric motor capable of starting the engine or more during creep running.

### CROSS-REFERENCE TO RELATED APPLICATION

This application is a National Stage entry of International Application No. PCT/JP2010/067890, filed Oct. 12, 2010, which claims priority to Japanese Patent Application No. 2009-293196, filed Dec. 24, 2009. The disclosures of the prior applications are incorporated in their entirety by reference.

### BACKGROUND OF THE INVENTION

1. Field of the Invention

The present invention relates to a hybrid vehicle which drives a driven unit with an electric motor and an internal combustion engine.

2. Related Background Art

In an engine-driven vehicle mounted with an automatic transmission system provided with a torque converter, a creep is generated, for example in the case where a drive range is selected, because the engine torque is transmitted to wheels via the torque converter even when an accelerator pedal and a brake pedal are not depressed. This creep is effective in moving the vehicle very slowly.

Patent Document 1 discloses a hybrid vehicle capable of performing creep running by a motor generator (an electric motor). In detail, the hybrid vehicle is equipped with an engine, the motor generator, and a split mechanism which is connected to the motor generator and wheels, and is connected to the engine via an input clutch. And, when a creep running is determined during engine-stopped state, the input clutch is engaged, the motor generator is made to output a constant torque, and a creep torque is generated using a cranking torque and an inertia torque of the engine as a reactive force. Further, at the time of starting the engine during creep control, the engine is driven via the input clutch by controlling the torque output of the motor generator, the engine is started by making an engine rotation number (rotational speed) to an engine starting rotation number (rotational speed).

### PRIOR ART REFERENCE

### Patent Document

[Patent Document 1] Japanese Patent No. 3671669

### SUMMARY OF THE INVENTION

### Problems to be Solved by the Invention

However, in the hybrid vehicle, in starting the engine during creep control, if the driving torque of the motor is comparatively low, the engine cannot be made to the engine starting rotational speed by the motor, so that there is a fear that the engine starting cannot be accomplished.

The present invention has been made in view of the above background, and aims at providing a hybrid vehicle capable of starting the engine comparatively easily and surely by the electric motor during creep running.

### Means for Solving the Problems

To attain an object described above, the present invention provides a hybrid vehicle comprising an electric motor and an internal combustion engine capable of transmitting motive power to a driven unit via a motive power transmission shaft of a motive power transmitting device, and which is capable of starting the internal combustion engine with the electric motor; wherein the motive power transmitting device comprises a connecting-disconnecting device capable of connecting and disconnecting between the internal combustion engine and the electric motor; and the hybrid vehicle comprises a controller which drive controls the electric motor so that a creep speed which is a target vehicle speed is achieved during creep running, in the state where the connection between the internal combustion engine and the electric motor is disconnected by the connecting-disconnecting device and in the state where the internal combustion engine is stopped; wherein the controller sets a creep rotational speed of the electric motor corresponding to the creep speed to be larger by a predetermined rotational speed than a starting-enabled rotational speed of the internal combustion engine, and start controls the internal combustion engine at equal to or more than the starting enabled rotational speed by a motive power of the electric motor, at the rotational speed of the electric motor at equal to or more than the starting enabled rotational speed during the creep running, and if a starting condition of the internal combustion engine is satisfied.

According to the hybrid vehicle of the present invention, the controller drive controls the electric motor so that the a creep speed which is a target vehicle speed is achieved during creep running, in the state where the connection between the internal combustion engine and the electric motor is disconnected by the connecting-disconnecting device and in the state where the internal combustion engine is stopped. The controller sets a creep rotational speed of the electric motor corresponding to the creep speed to be larger by a predetermined rotational speed than a starting-enabled rotational speed of the internal combustion engine.

The controller controls the internal combustion engine so as to be capable of starting, by making the internal combustion engine to be equal to or more than the starting enabled rotational speed by a motive power of the electric motor, by connecting the internal combustion engine and the electric motor by the connecting-disconnecting device, at the rotational speed of the electric motor at equal to or more than the starting enabled rotational speed during the creep running, and if a starting condition of the internal combustion engine is satisfied.

That is, by making the internal combustion engine to be equal to or more than the starting enabled rotational speed by the motive power of the electric motor, by connecting the internal combustion engine and the electric motor during creep running when the rotational speed of the electric motor is equal to or more than the starting enabled rotational speed of the internal combustion engine, it becomes possible to start the internal combustion engine comparatively easily and surely, without performing cumbersome operation.

The above-mentioned motive power transmitting device may be equipped with a plurality of transmission stages having different transmission ratios. Further, the hybrid vehicle may further comprise a transmission stage detector which detects the transmission stage selected by the motive power transmitting device, and a shaft rotational speed detector which detects the rotational speed of the power transmission shaft which is connectable to the internal combustion engine via the connecting-disconnecting device. In this case, the controller may drive control the electric motor so that the rotational speed of the motive power transmitting shaft becomes a predetermined rotational speed, during creep running, in the case where the transmission stage detected by the transmission stage detector is a 1st-speed stage. The predetermined rotational speed corresponds to the rotational speed of the electric motor, for example when the vehicle becomes the creep speed.

That is, during creep running, the controller is capable of controlling the vehicle to become the creep speed relatively easily, by drive controlling the electric motor so that the rotational speed of the motive power transmitting shaft to be a predetermined rotational speed.

Further, the above-mentioned hybrid vehicle may further be equipped with a temperature detector which detects a temperature of the internal combustion engine. In this case, the controller may define the creep speed to become larger, as the temperature detected by the temperature detector becomes lower.

That is, by defining the creep speed to be larger as the temperature detected by the temperature detector becomes lower, the controller is capable of starting the internal combustion engine surely with the electric motor, even in the case where the temperature of the internal combustion engine is comparatively low.

Further, the above-mentioned controller may perform control so as to suppress the driving of the electric motor, in the case where the vehicle speed continues for a predetermined time or more at a predetermine speed or less during the creep running.

That is, during the creep running, in the case where the vehicle speed continues at a predetermined speed or less (for example, in the vicinity of 0 km/h, more specifically about 2 km/h or less) for a predetermined time (for example, about 10 seconds) or more, it becomes possible to decrease the load of the electric motor by suppressing the driving of the electric motor, for example by preventing the electric motor from continuously outputting torque of a threshold value or more during parking of the vehicle.

Further, the above-mentioned controller may perform control so as to suppress the driving of the electric motor, in the case where the rotational speed of the electric motor is equal to or more than the creep rotational speed.

That is, during the creep running, in the case where the rotational speed of the electric motor is equal to or more than the creep rotational speed, it becomes possible to prevent the vehicle speed from becoming the creep speed or more, and also to prevent decrease of the efficiency of the electric motor, by suppressing the driving of the electric motor.

Further, the above-mentioned hybrid vehicle may comprise a tilt angle detector which detects a tilt angle of the vehicle, and a driving force setter which sets a driving force request. In this case, the controller may perform control so as to suppress the driving of the electric motor, in the case where it is determined that the vehicle is positioned at a downgrade, and that a set value by the driving force request by the driving force setter is equal to or less than a predetermined value.

That is, in the case where it is determined that the vehicle is positioned at a downgrade, and in the case where the set value by the driving force request by the driving force setter is equal to or less than the predetermined value, the controller determines that the driving force of the electric motor is not required, and suppresses driving of the electric motor. It becomes possible to prevent the vehicle from becoming comparatively high-speed, in the case where the vehicle is positioned in the downgrade during creep running.

### BRIEF DESCRIPTION OF THE DRAWINGS

FIG. 1 is an overall structural view of a hybrid vehicle of an embodiment of the present invention;

FIG. 2 is a functional block diagram of an ECU of the hybrid vehicle of the embodiment of the present invention;

FIG. 3 is a view for explaining a creep speed and an engine starting-enabled speed of the hybrid vehicle of the embodiment of the present invention;

FIG. 4 is a view for explaining a creep rotational speed and an engine starting-enabled rotational speed of an electric motor of the present embodiment, and (a) shows the creep rotational speed of the electric motor, and (b) shows the starting-enabled rotational speed of the engine;

FIG. 5 is a view indicating a relation between the creep speed and a temperature of the engine of the hybrid engine of the embodiment of the present invention;

FIG. 6 is a flowchart for explaining an operation of the hybrid vehicle of the embodiment of the present invention;

FIG. 7 is a flowchart for explaining the operation of a drive control during the creep running of the hybrid vehicle of the embodiment of the present invention; and

FIG. 8 is an overall structural view of the hybrid vehicle equipped with the motive power transmitting device of a second embodiment.

### DETAILED DESCRIPTION OF THE PREFERRED EMBODIMENTS

### First Embodiment

A hybrid vehicle according to a first embodiment of the present invention will be described. First, the configuration of the hybrid vehicle according to the first embodiment will be described.

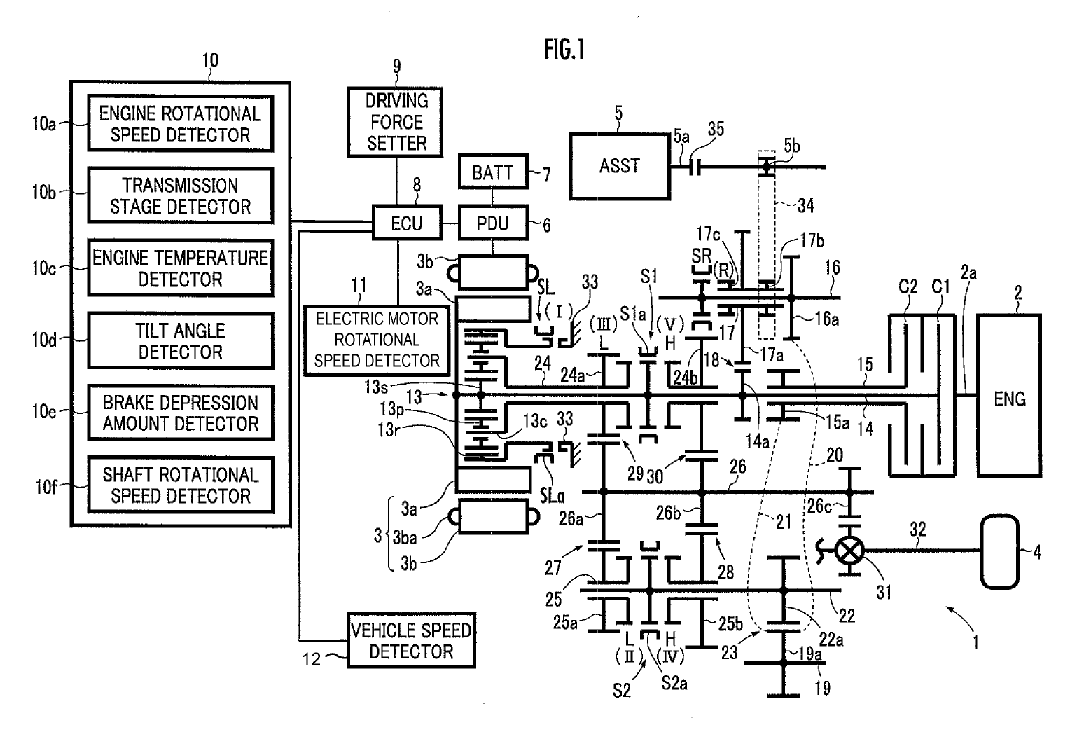

As illustrated in FIG. 1, the hybrid vehicle according to the first embodiment is provided with a motive power transmitting device 1 and also has an engine 2 as a motive power generating source and an electric motor (motor-generator) 3 capable of starting the engine 2. The engine 2 corresponds to the internal combustion engine in the present invention.

The motive power transmitting device 1 transmits the motive power (driving force) of the engine 2 and/or the electric motor 3 to drive wheels 4, which are driven parts, and is constructed to be capable of driving the drive wheels 4. Further, the motive power transmitting device 1 transmits the motive power from the engine 2 and/or the motive power from the drive wheels 4 to the electric motor 3 and is constructed to be capable of being regeneratively operated by the electric motor 3. The motive power transmitting device 1 is also constructed to be capable of driving an assist device 5 mounted in the vehicle by the motive power of the engine 2 and/or the electric motor 3. The assist device 5 is, for example, the compressor of an air conditioner, a water pump or an oil pump.

The engine 2 is, for example, an internal combustion engine that generates a motive power (torque) by burning a fuel, such as gasoline, light oil or alcohol. The engine 2 has a driving force input shaft 2a for inputting a generated motive power into the motive power transmitting device 1. As with a standard automobile engine, the engine 2 is controlled by controlling the opening degree of a throttle valve provided in an intake passage not shown (controlling the air intake volume of the engine 2) to adjust the motive power generated by the engine 2.

The electric motor 3 is a three-phase DC brushless motor in the first embodiment. The electric motor 3 has a hollow rotor (rotating body) 3a rotatably supported in a housing and a stator (stator) 3b. The rotor 3a in the first embodiment is provided with a plurality of permanent magnets. The stator 3b is wrapped with coils for the three phases (armature windings) 3ba. The stator 3b is secured to a housing provided on an immovable portion that is stationary with respect to a vehicle body, such as an exterior case of the motive power transmitting device 1.

The coil 3ba is electrically connected to a battery (an electricity storage device or a secondary cell) 7, which serves as a DC power source, through the intermediary of a power drive unit (hereinafter referred to as the “PDU”) 6, which is a drive circuit including an inverter circuit. Further, the PDU 6 is electrically connected to an electronic control unit (hereinafter referred to as the “ECU”) 8.

Upon receiving a control signal (a gate signal) which is a switching command from the ECU 8, the PDU 6 converts the direct current power supplied from the battery 7 to a three-phase alternating current power, by switching ON (conducted state)/OFF (non-conducted state) of a transistor (a switching element) which is paired for each phase of the inverter, on the basis of the control signal. Further, the PDU 6 converts the three-phase alternating current power to the direct current power, by switching the ON/OFF of the transistor.

The ECU 8 is electrically connected to constituent elements of the vehicle, such as the motive power transmitting device 1, the engine 2 and the electric motor 3, in addition to the PDU 6. The ECU 8 in the present embodiment is an electronic circuit unit which includes a CPU (Central processing unit), a RAM (Random access memory), a ROM (Read only memory), an interface circuit and the like, and carries out control processing specified by a program thereby to control the motive power transmitting device 1, the engine 2, the electric motor 3 and the like.

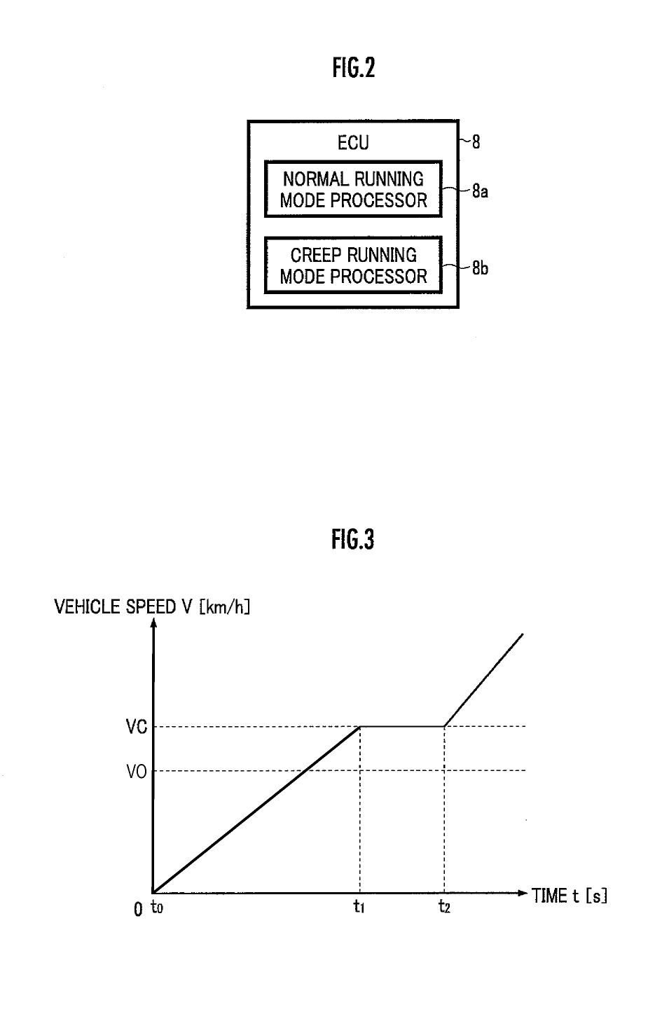

The ECU 8 has, as the means for implementing the functions in the present invention, a normal running mode processor 8a, and a creep running mode processor 8b, as illustrated in FIG. 2. The ECU 8 corresponds to the controller of the present invention. The functions of the ECU 8 will be described later.

The ECU 8 carries out control processing to control the function for controlling the operation of the engine 2 through the intermediary of an actuator for controlling the engine, such as an actuator for the throttle valve not shown, the function for controlling the operations of various clutches and the sleeves of various synchronizers, which will be discussed later, through the intermediary of actuators or drive circuits not shown, and the function which receives signals from a driving force setter 9, which sets a driving force required of the drive wheels 4 on the basis of a vehicle speed, the rotational speed of the engine 2 or the like, and controls the constituent elements on the basis of the required driving force or a traveling state.

Further, the ECU 8 controls, via the PDU 6, the current passing through the coil 3ba thereby to adjust the motive power (torque) output by the electric motor 3 from the rotor 3a. In this case, the PDU 6 is controlled to cause the electric motor 3 to perform a powered operation in which a power running torque is generated in the rotor 3a by the electric power supplied from the battery 7, thus functioning as a motor. In other words, the electric power supplied to the stator 3b is converted into the motive power by the rotor 3a and output. Further, the PDU 6 is controlled to cause the electric motor 3 to generate electricity by the rotational energy supplied to the rotor 3a and carries out a regenerative operation so as to produce a regenerative torque in the rotor 3a while charging the battery 7. This means that the electric motor 3 functions also as a generator. In other words, the motive power input to the rotor 3a is converted into electric power by the stator 3b.

The driving force setter 9 is capable of setting a driving force required of the drive wheels 4 according to, for example, the operation by a driver or a traveling state. The driving force setter 9 may use, for example, an acceleration sensor which is provided in an accelerator pedal and which detects the amount of depression of the accelerator pedal or a throttle opening degree sensor which detects the opening degree of a throttle.

Various sensors 10 include, for example, an engine rotational speed detector 10a, which detects the rotational speed of the engine, a transmission stage detector 10b, which detects the transmission stage, an engine temperature detector 10c, which detects the temperature of the engine, a tilt angle detector 10d, which detects the tilt angle of the vehicle, a brake depression amount detector 10e which detects the amount of depression of the brake, and a motive power transmission shaft rotational speed detector (shaft rotational speed detector) 10f, which detects the rotational speed of a motive power transmission shaft, and send signals indicative of detection results of the detectors (sensors) to the ECU 8.

An electric motor rotational speed detector 11 detects the rotational speed of the electric motor 3, and sends the detection result to the ECU 8. A vehicle speed detector 12 detects the vehicle speed of the vehicle, and sends the detection result to the ECU 8.

The constituent elements of the motive power transmitting device 1 in the first embodiment will now be described. The motive power transmitting device 1 has a motive power combining mechanism 13, which combines the motive power of the engine 2 and the motive power of the electric motor 3. As the motive power combining mechanism 13, a planetary gear device is adopted in the first embodiment. The motive power combining mechanism 13 will be discussed hereinafter.

A first main input shaft 14 is connected to the driving force input shaft 2a of the engine 2. The first main input shaft 14 is disposed in parallel to the driving force input shaft 2a and receives the motive power from the engine 2 through the intermediary of a first clutch C1. The first main input shaft 14 extends to the electric motor 3 from the engine 2. The first main input shaft 14 is configured such that it can be connected or disconnected to or from the driving force input shaft 2a of the engine 2 by the first clutch C1. Further, the first main input shaft 14 in the first embodiment is connected to the rotor 3a of the electric motor 3.

The first clutch C1 is controlled by the ECU 8 to connect or disconnect the driving force input shaft 2a and the first main input shaft 14. When the driving force input shaft 2a and the first main input shaft 14 are connected by the first clutch C1, the motive power can be transmitted between the driving force input shaft 2a and the first main input shaft 14. When the driving force input shaft 2a and the first main input shaft 14 are disconnected by the first clutch C1, the motive power transmitted between the driving force input shaft 2a and the first main input shaft 14 is cut off.

A first auxiliary input shaft 15 is disposed concentrically with respect to the first main input shaft 14. The first auxiliary input shaft 15 receives the motive power from the engine 2 through the intermediary of a second clutch C2. The second clutch C2 is controlled by the ECU 8 to connect or disconnect the driving force input shaft 2a and the first auxiliary input shaft 15. When the driving force input shaft 2a and the first auxiliary input shaft 15 are connected by the second clutch C2, the motive power can be transmitted between the driving force input shaft 2a and the first auxiliary input shaft 15. When the driving force input shaft 2a and the first auxiliary input shaft 15 are disconnected by the second clutch C2, the motive power transmitted between the driving force input shaft 2a and the first auxiliary input shaft 15 is cut off. The first clutch C1 and the second clutch C2 are adjacently disposed in the direction of the axial center of the first main input shaft 14. The first clutch C1 and the second clutch C2 in the first embodiment are composed of multiplate wet clutches.

As described above, the motive power transmitting device 1 is configured such that the first clutch C1 disengageably transmits the rotation of the driving force input shaft 2a to the first main input shaft 14 (a first drive gear shaft), while the second clutch C2 disengageably transmits the rotation of the driving force input shaft 2a to a second main input shaft 22 (a second drive gear shaft).

A reverse shaft 16 is disposed in parallel to the first main input shaft 14. A reverse gear shaft 17 is rotatably supported on the reverse shaft 16. The first main input shaft 14 and the reverse gear shaft 17 are connected at all times through the intermediary of a gear train 18. The gear train 18 is configured by a gear 14a fixed on the first main input shaft 14 and a gear 17a provided on the reverse gear shaft 17, which gears are meshed with each other.

The reverse shaft 16 is provided with a reverse synchronizer SR capable of switching between the connection and disconnection between a reverse gear 17c fixed on the reverse gear shaft 17 and the reverse shaft 16.

An intermediate shaft 19 is disposed in parallel to the reverse shaft 16 and consequently to the first main input shaft 14. The intermediate shaft 19 and the reverse shaft 16 are connected at all times through the intermediary of a gear train 20. The gear train 20 is constituted by a gear 19a fixed on the intermediate shaft 19 and a gear 16a fixed on the reverse shaft 16, which gears are meshed with each other. The intermediate shaft 19 and the first auxiliary input shaft 15 are connected at all times through the intermediary of a gear train 21. The gear train 21 is constituted by a gear 19a fixed on the intermediate shaft 19 and a gear 15a fixed on the first auxiliary input shaft 15, which gears are meshed with each other.

A second main input shaft 22 is disposed in parallel to the intermediate shaft 19 and the first main input shaft 14. The second main input shaft 22 and the intermediate shaft 19 are connected at all times through the intermediary of a gear train 23. The gear train 23 is composed of a gear 19a fixed on the intermediate shaft 19 and a gear 22a fixed on the third main input shaft, which gears are meshed with each other.

The first main input shaft (the first drive gear shaft) 14 rotatably supports the drive gear of each gear train of an odd-numbered or an even-numbered transmission stage in terms of the order of transmission ratio among a plurality of transmission stages having different transmission ratios (odd-numbered transmission stages, namely, a 3rd-speed stage and a 5th-speed stage in the first embodiment), and is connected to the electric motor 3.

Specifically, a second auxiliary input shaft 24 is disposed concentrically with the first main input shaft 14. The second auxiliary input shaft 24 is disposed more closely to the electric motor 3 than the first auxiliary input shaft 15. The first main input shaft 14 and the second auxiliary input shaft 24 are connected through the intermediary of a first synchronous engaging mechanism S1 (a synchromesh mechanism in the present embodiment). The first synchronous engaging mechanism S1 is provided on the first main input shaft 14 and selectively connects a 3rd-speed gear 24a and a 5th-speed gear 24b to the first main input shaft 14. Specifically, the first synchronous engaging mechanism S1 is a synchromesh clutches or the like, which is widely known, and a sleeve S1a is moved in the axial direction of the second auxiliary input shaft 24 by an actuator and a shift fork, not shown, thereby selectively connecting the 3rd-speed gear 24a and the 5th-speed gear 24b to the first main input shaft 14. More specifically, if the sleeve S1a is moved from the neutral position in the drawing toward the 3rd-speed gear 24a, then the 3rd-speed gear 24a and the first main input shaft 14 are connected. Meanwhile, if the sleeve S1a is moved from the neutral position in the drawing toward the 5th-speed gear 24b, then the 5th-speed gear 24b and the first main input shaft 14 are connected.

The second main input shaft (the second drive gear shaft) 22 rotatably supports the drive gear of each gear train of an even-numbered or an odd-numbered transmission stage in terms of the order of transmission ratio among a plurality of transmission stages having different transmission ratios (even-numbered transmission stages, namely, a 2nd-speed stage and a 4th-speed stage in the present embodiment). Specifically, a third auxiliary input shaft 25 is disposed concentrically with the second main input shaft 22. The second main input shaft 22 and the third auxiliary input shaft 25 are connected through the intermediary of a second synchronous engaging mechanism S2 (a synchromesh mechanism in the present embodiment). The second synchronous engaging mechanism S2 is provided on the second main input shaft 22 and selectively connects a 2nd-speed gear 25a and a 4th-speed gear 25b to the second main input shaft 22. The second synchronous engaging mechanism S2 is a synchromesh clutches or the like, which is widely known, and a sleeve S2a is moved in the axial direction of the third auxiliary input shaft 25 by an actuator and a shift fork, not shown, thereby selectively connecting the 2nd-speed gear 25a and the 4th-speed gear 25b to the second main input shaft 22. If the sleeve S2a is moved from the neutral position in the drawing toward the 2nd-speed gear 25a, then the 2nd-speed gear 25a and the second main input shaft 22 are connected. Meanwhile, if the sleeve S2a is moved from the neutral position in the drawing toward the 4th-speed gear 25b, then the 4th-speed gear 25b and the second main input shaft 22 are connected.

The third auxiliary input shaft 25 and the output shaft 26 are connected through the intermediary of a 2nd-speed gear train 27. The 2nd-speed gear train 27 is constituted of a gear 25a fixed on the third auxiliary input shaft 25 and a gear 26a fixed on the output shaft 26, which gears are meshed with each other. Further, the third auxiliary input shaft 25 and the output shaft 26 are connected through the intermediary of a 4th-speed gear train 28. The 4th-speed gear train 28 is constituted of a gear 25b fixed on the third auxiliary input shaft 25 and a gear 26b fixed on the output shaft 26.

The output shaft 26 and the second auxiliary input shaft 24 are connected through the intermediary of a 3rd-speed gear train 29. The 3rd-speed gear train 29 is constituted of a gear 26a fixed on the output shaft 26 and a gear 24a fixed on the second auxiliary input shaft 24. Further, the output shaft 26 and the second auxiliary input shaft 24 are connected through the intermediary of a 5th-speed gear train 30. The 5th-speed gear train 30 is constituted of a gear 26b fixed on the output shaft 26 and a gear 24b fixed on the second auxiliary input shaft 24. The gears 26a and 26b of the gear trains fixed on the output shaft 26 are referred to as driven gears.

Further, a final gear 26c is fixed on the output shaft 26. The rotation of the output shaft 26 is transmitted to the drive wheels 4 through the intermediary of the final gear 26c, a differential gear unit 31 and an axle 32.

The motive power combining mechanism 13 in the present embodiment is provided inside the electric motor 3. Some or all of the rotor 3a, the stator 3b and the coil 3ba constituting the electric motor 3 are disposed such that they overlap with the motive power combining mechanism 13 in the direction that is orthogonal to the axial direction of the first main input shaft 14.

The motive power combining mechanism 13 is formed of a differential device capable of differentially rotating a first rotating element, a second rotating element, and a third rotating element. The differential device constituting the motive power combining mechanism 13 in the present embodiment is a single-pinion type planetary gear device concentrically provided with three rotating elements, namely, a sun gear 13s (a first rotating element), a ring gear 13r (a second rotating element), and a carrier (a third rotating element) 13c rotatably supporting a plurality of planetary gears 13p, which are sandwiched between the sun gear 13s and the ring gear 13r and which are meshed with the sun gear 13s and the ring gear 13r. These three rotating elements 13s, 13r and 13c are capable of mutually transmitting motive power and rotate while maintaining a certain collinear relationship among their numbers of rotations (rotational speeds).

The sun gear 13s is secured to the first main input shaft 14 such that it rotates in conjunction with the first main input shaft 14. The sun gear 13s is also secured to the rotor 3a such that it rotates in conjunction with the rotor 3a of the electric motor 3. Thus, the sun gear 13s, the first main input shaft 14, and the rotor 3a rotate in conjunction with each other.

The ring gear 13r is configured such that it can be switched between a state wherein it is secured to a housing 33, which is immovable, and a state wherein it is not fixed, by a third synchronous engaging mechanism SL. More specifically, the ring gear 13r is configured such that it can be switched between a state, wherein it is fixed to the housing 33, and a state, wherein it is not fixed, by moving a sleeve SLa of the third synchronous engaging mechanism SL in the direction of the rotational axis of the ring gear 13r.

The carrier 13c is connected to one end of the second auxiliary input shaft 24, which end is adjacent to the electric motor 3, such that the carrier 13c rotates in conjunction with the second auxiliary input shaft 24.

An input shaft 5a of the assist device 5 is disposed in parallel to the reverse shaft 16. The reverse shaft 16 and the input shaft 5a of the assist device 5 are connected through the intermediary of, for example, a belt mechanism 34. The belt mechanism 34 is formed by a gear 17b fixed on the reverse gear shaft 17 and a gear 5b fixed on the input shaft 5a, which gears are connected through a belt. The input shaft 5a of the assist device 5 is provided with an assist device clutch 35. The gear 5b and the input shaft 5a of the assist device 5 are concentrically connected through the intermediary of the assist device clutch 35.

The assist device clutch 35 is a clutch that acts to connect or disconnect the gear 5b and the input shaft 5a of the assist device 5 under the control of the ECU 8. In this case, if the assist device clutch 35 is set in a connection mode, then the gear 5b and the input shaft 5a of the assist device 5 are connected through the intermediary of the assist device clutch 35 such that the gear 5b and the input shaft 5a of the assist device 5 rotate together as one piece. If the assist device clutch 35 is placed in a disconnection mode, then the connection between the gear 5b and the input shaft 5a of the assist device 5 engaged by the assist device clutch 35 is cleared. In this state, the motive power transmitted to the first auxiliary input shaft 15 and the input shaft 5a of the assist device 5 is cut off.

Each of the transmission stages will now be explained. As described above, the motive power transmitting device 1 in the present embodiment is constructed to change the rotational speed of the input shaft into a plurality of stages through the intermediary of the gear trains of the plurality of transmission stages having different transmission ratios and output the changed speed in the plurality of stages to the output shaft 26. In the motive power transmitting device 1, as the gear shaft stage increases, the transmission ratios decrease.

At the time of an engine startup, the first clutch C1 is connected and the electric motor 3 is driven to start the engine 2. In other words, the electric motor 3 functions also as a starter.

A 1st-speed stage is established by setting the ring gear 13r and the housing 33 in a connected state (fixed state) by the third synchronous engaging mechanism SL. When traveling on the engine 2, the second clutch C2 is set in a cutoff state (hereinafter referred to as the OFF state) and the first clutch C1 is set in a connected state (hereinafter referred to as the ON state). The driving force output from the engine 2 is transmitted to the drive wheels 4 through the intermediary of the sun gear 13s, the carrier 13c, the gear train 29, the output shaft 26 and the like.

Driving the engine 2 and the electric motor 3 permits an assist travel on the electric motor 3 at the 1st-speed stage (a travel mode in which the driving force of the engine 2 is assisted by the electric motor 3). Further, setting the first clutch C1 in the OFF state makes it possible to engage an EV travel mode, in which the vehicle travels on the electric motor 3 alone.

Further, during a deceleration regenerative drive, electricity can be generated by the electric motor 3 by placing the vehicle in a deceleration mode by braking the electric motor 3, thus charging the battery 7 through the intermediary of the PDU 6.

A 2nd-speed stage is established by setting the ring gear 13r and the housing 33 in the non-fixed state by the third synchronous engaging mechanism SL, while setting the second synchronous engaging mechanism S2 in the state wherein the second main input shaft 22 and the 2nd-speed gear 25a are connected. For traveling on the engine 2, the second clutch C2 is set to the ON state. At the 2nd-speed stage, the driving force output from the engine 2 is transmitted to the drive wheels 4 through the intermediary of the first auxiliary input shaft 15, the gear train 21, the intermediate shaft 19, the gear train 23, the second main input shaft 22, the 2nd-speed gear train 27, and the output shaft 26.

With the first clutch C1 set to the ON state, the assist travel by the electric motor 3 at the 2nd-speed stage can be performed by driving the engine 2 and also driving the electric motor 3. Further, stopping the drive on the engine 2 in this state allows the EV travel to be performed. In the case where the drive on the engine 2 is stopped, the engine 2 may be set in, for example, a fuel-cut state or a cylinder cutoff state. Further, the deceleration regenerative drive can be accomplished at the 2nd-speed stage.

If the ECU 8 determines that an upshift to the 3rd-speed stage is expected according to the traveling state of the vehicle while the vehicle is traveling at the 2nd-speed stage by driving the engine 2, the first clutch C1 being set in the OFF state and the second clutch C2 being set in the ON state, then a state wherein the first main input shaft 14 and the 3rd-speed gear 24a are connected by the first synchronous engaging mechanism S1 is set or a pre-shift state close thereto is set. This permits smooth upshift from the 2nd-speed stage to the 3rd-speed stage.

A 3rd-speed stage is established by setting the first synchronous engaging mechanism S1 in the state wherein the first main input shaft 14 and the 3rd-speed gear 24a are connected. When the vehicle travels on the engine 2, the first clutch C1 is set to the ON state. At the 3rd-speed stage, the driving force output from the engine 2 is transmitted to the drive wheels 4 through the intermediary of the first main input shaft 14, the 3rd-speed gear train 29, and the output shaft 26.

With the first clutch C1 set to the ON state, the assist travel by the electric motor 3 at the 3rd-speed stage can be performed by driving the engine 2 and also driving the electric motor 3. Further, the EV travel can be performed, with the first clutch C1 set to the OFF state. Setting the first clutch C1 to the ON state and stopping the drive on the engine 2 permits the EV travel. Further, the deceleration regenerative drive can be accomplished at the 3rd-speed stage.

While the vehicle is traveling at the 3rd-speed stage, the ECU 8 predicts whether the next transmission stage to be engaged for gear shifting will be the 2nd-speed stage or the 4th-speed stage according to the traveling condition of the vehicle. If the ECU 8 predicts a downshift to the 2nd-speed stage, then the second synchronous engaging mechanism S2 is set to a state wherein the 2nd-speed gear 25a and the second main input shaft 22 are connected or a pre-shift state close thereto is set. If the ECU 8 predicts an upshift to the 4th-speed stage, then the second synchronous engaging mechanism S2 is set to a state wherein the 4th-speed gear 25b and the second main input shaft 22 are connected or a pre-shift state close thereto. This permits smooth upshift and downshift from the 3rd-speed stage.

A 4th-speed stage is established by setting the second synchronous engaging mechanism S2 to the state wherein the second main input shaft 22 and the 4th-speed gear 25b are connected. When the vehicle travels on the engine 2, the second clutch C2 is set to the ON state. At the 4th-speed stage, the driving force output from the engine 2 is transmitted to the drive wheels 4 through the intermediary of the first auxiliary input shaft 15, the gear train 21, the intermediate shaft 19, the gear train 23, the second main input shaft 22, the 4th-speed gear train 28, and the output shaft 26. Further, the deceleration regenerative drive can be accomplished at the 4th-speed stage.

With the second clutch C2 set to the ON state and the first clutch C1 set to the ON state, driving the engine 2 and the electric motor 3 permits an assist travel on the electric motor 3 at the 4th-speed stage. Further, stopping the drive on the engine 2 in this state permits the EV travel.

Further, while the vehicle is traveling at the 4th-speed stage by driving the engine 2, with the first clutch C1 set to the OFF state and the second clutch C2 set to the ON state, the ECU 8 predicts whether the next transmission stage to be engaged for gear shifting will be the 3rd-speed stage or a 5th-speed stage. If the ECU 8 predicts a downshift to the 3rd-speed stage, then the state wherein the first main input shaft 14 and the 3rd-speed gear 24a are connected or a pre-shift state close thereto is set by the first synchronous engaging mechanism S1. If the ECU 8 predicts an upshift to the 5th-speed stage, then the state wherein the first main input shaft 14 and the 5th-speed gear 24b are connected or a pre-shift state close thereto is set by the first synchronous engaging mechanism S1. This permits smooth upshift and downshift from the 4th-speed stage.

The 5th-speed stage is established by setting the first synchronous engaging mechanism S1 to the state wherein the first main input shaft 14 and the 5th-speed gear 24b are connected. For traveling on the engine 2, the first clutch C1 is set to the ON state. At the 5th-speed stage, the driving force output from the engine 2 is transmitted to the drive wheels 4 through the intermediary of the first main input shaft 14, the 5th-speed gear train 30, and the output shaft 26.

With the first clutch C1 set to the ON state, the assist travel by the electric motor 3 at the 5th-speed stage can be performed by driving the engine 2 and also driving the electric motor 3. Further, the EV travel can be performed, with the first clutch C1 being set to the OFF state. Moreover, with the first clutch C1 set to the ON state and the drive on the engine 2 being stopped, the EV travel can be performed. In addition, the deceleration regenerative drive can be accomplished at the 5th-speed stage.

If the ECU 8 determines that the next transmission stage to be engaged for gear shifting will be the fourth-speed stage according to the traveling state of the vehicle while the vehicle is traveling at the 5th-speed stage, then the ECU 8 sets the second synchronous engaging mechanism S2 to a state wherein the 4th-speed gear 25b and the second main input shaft 22 are connected or a pre-shift state close thereto. This permits smooth downshift from the 5th-speed stage to the 4th-speed stage.

The reverse stage is established by setting a reverse synchronous engaging mechanism SR to a state wherein the reverse shaft 16 and the reverse gear 17c are connected and by setting the second synchronous engaging mechanism S2 to a state wherein, for example, the second main input shaft 22 and the 2nd-speed gear 25a are connected. When traveling on the engine 2, the first clutch C1 is set to the ON state. At the reverse stage, the driving force output from the engine 2 is transmitted to the drive wheels 4 through the intermediary of the first main input shaft 14, the gear train 18, the reverse gear 17c, the reverse shaft 16, the gear train 20, the intermediate shaft 19, the gear train 23, the second main input shaft 22, the third auxiliary input shaft 25, the gear train 27, and the output shaft 26, and the like. Driving the engine 2 and also driving the electric motor 3 permits the assist travel by the electric motor 3 at the reverse stage. Further, the EV travel can be performed by setting the first clutch C1 to the OFF state. In addition, the deceleration regenerative drive can be accomplished at the reverse stage.

The function of the ECU 8 according to the present embodiment illustrated in FIG. 2 will now be explained.

The normal running mode processor 8a performs process during a normal running mode. The normal running mode includes, for example, running modes other than the creep running, for example, an acceleration running mode, a deceleration regenerative mode, an engine running mode, and the like.

The creep running mode processor 8b determines whether or not a creep running condition is satisfied, according to for example the vehicle speed, the amount of depression of the accelerator pedal, the amount of depression of the brake pedal, and the like. When it is determined that the creep running condition is satisfied, the creep running mode processor 8b performs process according to the creep running mode.

As the creep running condition, for example, (a) a state where the vehicle speed is smaller than a creep speed, (b) a state where the brake pedal is not depressed, (c) a stopped state of the engine 2, (d) a state where the connection between the engine 2 and the electric motor 3 is disconnected by the first clutch C1, (e) a state where the drive range or the 1st-speed stage through the 3rd-speed stage is selected as the shift position, and (f) a state where the vehicle is not positioned at a downgrade, and the like. In the case where all of or a part of the above-mentioned conditions (a) through (f) are satisfied, the ECU 8 transits to the creep running mode.

The creep running mode processor 8b drive controls the electric motor 3 during the creep running mode, so that the vehicle speed becomes the creep speed as the target speed. At this time, a creep rotational speed of the electric motor 3 corresponding to the creep speed is set so as to become larger than a starting-enabled rotational speed of the engine 2 by a predetermined rotational speed. By doing so, for example in the case where the drive range is selected, the vehicle is capable of traveling at a minute speed, by the torque of the electric motor 3 being transmitted to the drive wheels via the motive power transmitting device 1 in the state where the brake pedal is not depressed.

In the present embodiment, the ECU 8 performs the engine starting process, in the case where an engine starting condition is satisfied (for example, in the case where the driving force of the engine 2 becomes necessary) during the creep running mode and when the rotating speed of the electric motor 3 is equal to or more than the engine starting-enabled rotational speed. More specifically, when the first clutch C1 is set to the ON state, the motive power from the electric motor 3 and the drive wheels 4 is transmitted to the engine 2 via the first clutch C1, and the engine 2 rotates at the starting-enabled speed or more. At this state, when the fuel is supplied to the engine 2, the engine 2 starts.

The creep running mode processor 8b performs control so that the rotational speed of a main shaft (for example, the first main input shaft 14) becomes the predetermined rotational speed, in the case where the transmission stage is set to the 1st-speed stage during the creep running mode. More specifically, the creep running mode processor 8b drive controls the electric motor 3 so that the rotational speed of the first main input shaft 14 (the main shaft) becomes the predetermined rotational speed, in the case where the transmission stage detected by the transmission stage detector 10b is the 1st-speed stage. As is explained above, the engine 2 is capable of connecting to the first main input shaft 14 (the main shaft) via the first clutch C1 (engagement-disengagement device).

Further, in the case where a driving force constraining condition during the creep running is satisfied, the creep running mode processor 8b performs control so as to constrain the drive of the electric motor 3 during creep running. More specifically, the creep running mode processor 8b determines that the driving force constraining condition is satisfied, and constrains the drive of the electric motor 3, when the vehicle speed is equal to or less than a predetermined speed (for example, in the vicinity of 0 km/h, more specifically about 2 km/h or less), and this state has continued for a predetermined time (for example, about 10 seconds) in the creep running mode.

Further, in the case where the vehicle speed is equal to or more than the creep speed, the creep running mode processor 8b determines that the driving force constraining condition is satisfied, and constrains the drive of the electric motor 3.

Further, the creep running mode processor 8b determines that the driving force constraining condition is satisfied, and constrains the drive of the electric motor 3, when it is determined that the vehicle is positioned at the downgrade on the basis of the detection result of the tilt angle detector 10d, and also in the case where the set value by the driving force request by the driving force setter 9 is equal to or smaller than the predetermined value.

The operation of the hybrid vehicle of the present embodiment will be explained with reference to FIG. 3. In the hybrid vehicle of the present embodiment, the electric motor 3 is connected to the output shaft 26 via the transmission stage of the motive power transmitting device 1, and the torque of the electric motor 3 is capable of being transmitted to the drive wheels 4 via the output shaft 26. More specifically, the motive power transmitting device 1 is equipped with the 1st-speed stage with a comparatively large transmission ratio. The hybrid vehicle is set to EV running mode at the time of starting. That is, the state where the connection between the engine 2 and the electric motor 3 is disconnected by the first clutch C1. This is the state where the third synchronous engaging mechanism SL is set to the ON state, and the 1st-speed stage is substantially selected by the planetary gear mechanism, and the drive wheels 4 are driven by the electric motor 3 via the motive power transmitting device 1.

In the present embodiment, a creep speed VC as the target speed of the vehicle is set to equal to or more than an engine starting-enabled speed V0. The engine starting-enabled speed V0 corresponds to the vehicle speed in the case where the transmission stage of the motive power transmitting device 1 is set to the 1st-speed stage and the like, in the case where the rotational speed of the electric motor 3 is the engine starting-enabled rotating speed. In the present embodiment, the creep speed as the target vehicle speed is set, for example, to 10 km/h.

Subsequently, explanation will be given on the operation in the state where the vehicle is approximately stopped, the state where the connection between the engine 2 and the electric motor 3 is disconnected by the first clutch C1, the state where the engine 2 is stopped, a drive range or the 1st-speed stage, the 3rd-speed stage is selected as the shift position, and the state where the brake pedal is depressed is switched to the state where the same is not depressed.

From time t0 to time t1, the hybrid vehicle drive controls the electric motor 3 so that the speed becomes the creep speed which is the target speed during creep running mode. At time t1, when the speed reaches the creep speed VC, the hybrid vehicle limits the driving force of the electric motor 3. From time t1 to time t2, the hybrid vehicle controls the electric motor 3 so as to maintain the creep speed VC.

At time t2, in the case where the engine starting condition is satisfied, for example when the driving force request is larger than a prescribed value, the hybrid vehicle start controls the engine 2. At this time, the vehicle speed is higher than an engine starting-enabled speed. When the engine 2 and the electric motor 3 are connected via the first main input shaft 14 by the first clutch C1, the torque of the electric motor 3 is transmitted to the engine 2, and the crank shaft of the engine 2 rotates at equal to or more than an engine starting-enabled rotational speed. When the fuel is supplied to the engine 2 at this state, it becomes possible to easily start the engine 2.

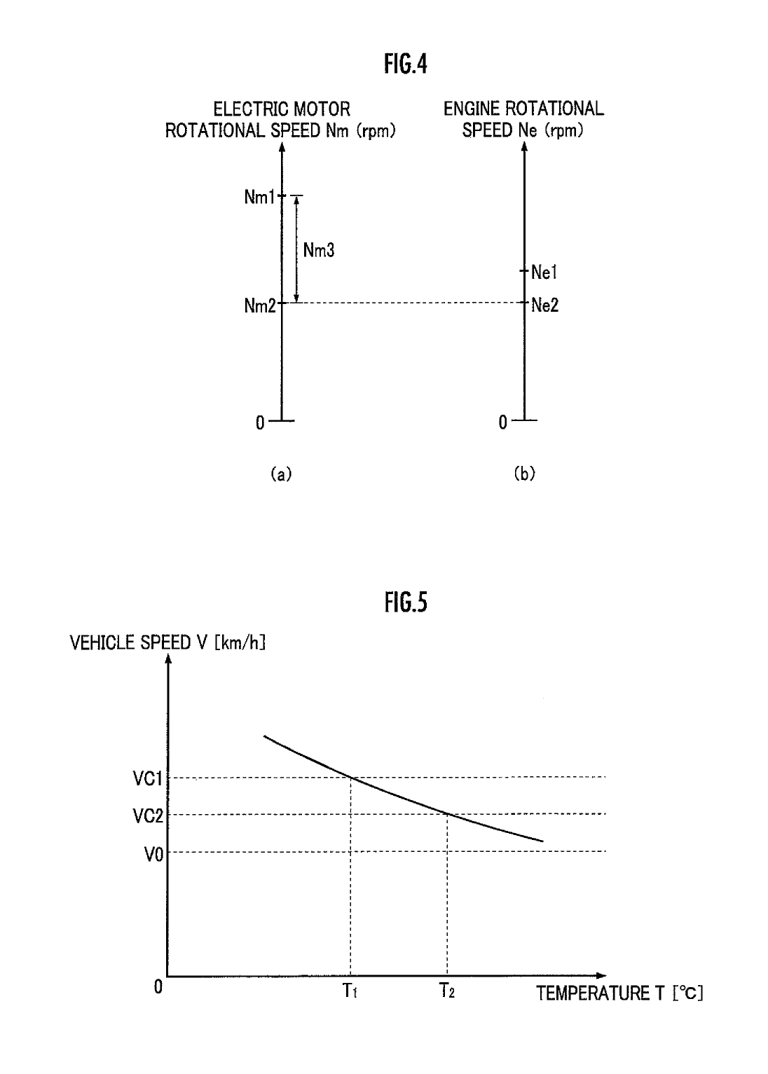

Next, with reference to FIG. 4, the operation of the hybrid vehicle of the present embodiment will be explained.

A creep rotational speed Nm1 of the electric motor 3 corresponds to the rotational speed of the electric motor 3 when the vehicle is running at the creep speed VC in the case where the transmission stage of the motive power transmitting device 1 is set to the 1st-speed stage and the like. The creep rotational speed Nm1 of the electric motor 3 of the present embodiment is set to be larger than an engine starting-enabled rotational speed Nm2. In detail, the creep rotational speed Nm1 of the electric motor 3 is set to be larger by a predetermined rotational speed than an engine starting-enabled rotational speed Ne2, in order to start the engine 2 by the electric motor 3. In the present embodiment, the engine starting-enabled rotational speed Ne2 is set lower than an idle rotational speed Ne1 of the engine 2.

Further, the creep rotational speed Nm1 of the present embodiment is obtained by adding, for example, the engine starting-enabled rotational speed Ne2 (Nm2) and a margin (a margin rotational speed) Nm3 such as a rotational speed corresponding to a reverse torque during connection of the engine 2 and the electric motor 3 by the first clutch C1. That is, the predetermined rotational speed mentioned above corresponds to Nm3.

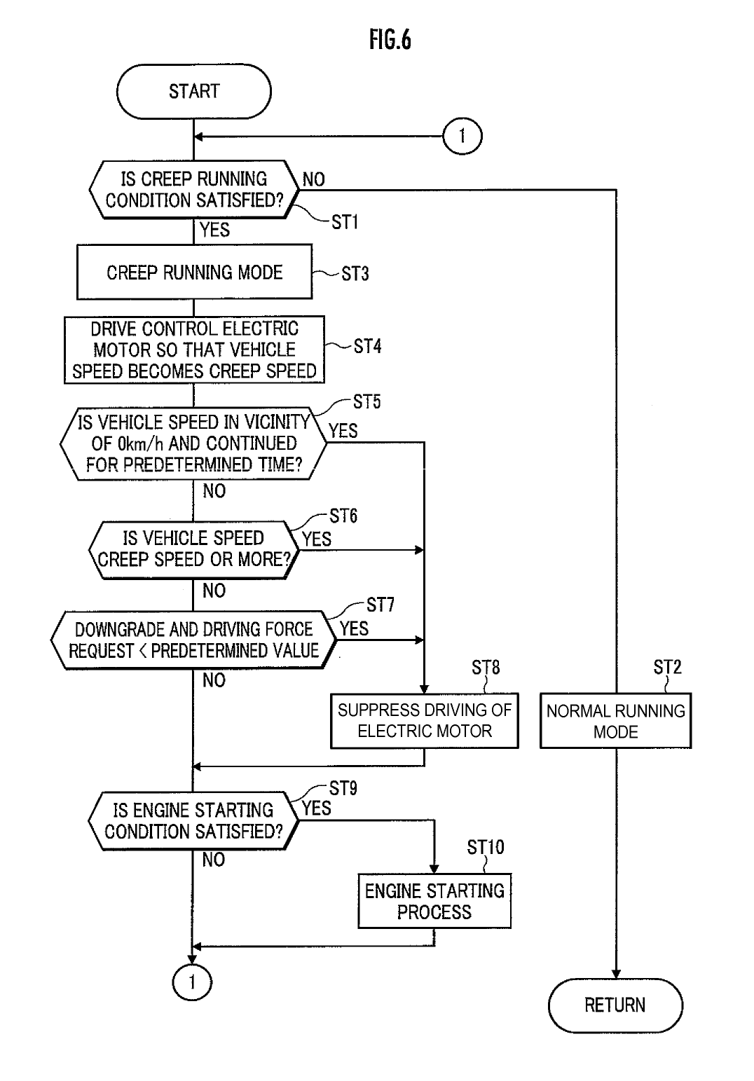

Next, with reference to FIG. 5, relationship between the creep speed and the temperature of the engine 2 of the hybrid vehicle of the present embodiment will be explained. As is shown in FIG. 5, the ECU 8 defines the creep speed VC of the vehicle, according to the temperature of the engine 2 detected by the engine temperature detector 10c. The torque necessary for engine starting during an engine low-temperature T1 is large compared to that during an engine high-temperature T2. Therefore, in the present embodiment, the creep speed VC is corrected so as to become larger as the temperature of the engine 2 decreases. In detail, a creep speed VC1 during the engine low-temperature T1 is set so as be larger compared to a creep speed VC2 during the engine high-temperature T2. Specifically, the margin rotational speed Nm3 during the engine low-temperature T1 is defined so as to become larger than that during the engine high-temperature T2.

By doing so, in the case where the engine starting condition is satisfied during creep running, it becomes possible to surely start the engine 2 by the electric motor 3, even in the case where the temperature of the engine 2 is comparatively low.

Next, with reference to FIG. 6, the operation of the hybrid vehicle of the present embodiment will be explained.

In step ST1, the ECU 8 determines whether or not the creep running condition is satisfied. In the case where it is determined that the creep running condition is satisfied, the ECU 8 proceeds to the process of step ST3, and in the case where it is determined that the creep running condition is not satisfied, the ECU 8 proceeds to the process of step ST2.

In step ST2, the ECU 8 sets the normal running mode. During the normal running mode, the ECU 8 controls the motive power transmitting device 1, the engine 2, and the electric motor 3 according to the driving force request, the vehicle speed, the transmission stage and the like.

In step ST3, the ECU 8 transits to the creep running mode, in the case where the creep running condition is satisfied. During the creep running mode, the ECU 8 performs, for example, the process of steps ST5 through ST10 mentioned below.

In step ST4, the ECU 8 drive controls the electric motor 3, so that the vehicle speed becomes the target speed (creep speed) during creep running mode. Step ST4 will be explained later.

Next, it is determined whether or not the driving force constraining condition during the creep running. For example, steps ST5 through ST7 may be listed as the driving force constraining condition. The order of steps ST5 through ST7 is not limited to that in the present embodiment.

In step ST5, the ECU 8 determines whether or not the vehicle speed is in the vicinity of 0 km/h and this state has continued for a predetermined time (for example, approximately 10 seconds). In the case where the above-mentioned condition is satisfied, the process proceeds to step ST8, and in the case where the above-mentioned condition is not satisfied, then the process proceeds to step ST6.

In step ST6, the ECU 8 determines whether or not the vehicle speed of the vehicle detected by the vehicle speed detector 12 is equal to or more than the creep speed. As a result of determination, the ECU 8 proceeds to the process of step ST8 in the case it is determined that the vehicle speed is equal to or more than the creep speed, and proceeds to the process of step ST7 in cases other than that.

In step ST7, the ECU 8 determines whether or not the vehicle is positioned at a downgrade, and also the driving force request is equal to or smaller than a predetermined value. The determination of whether or not the vehicle is positioned at a downgrade is, for example, determined on whether or not the front of the vehicle is inclined lower than the rear of the vehicle, on the basis of the determination result of the tilt angle detector 10d. In the case where the above-mentioned condition is satisfied, the ECU 8 proceeds to the process of step ST8, and transits to the normal mode. In the case where the above-mentioned condition is not satisfied, the ECU 8 proceeds to the process of step ST9.

At step ST8, the ECU 8 performs control so as to suppress driving of the electric motor 3 (a driving force constraining mode during creep running), in the case where the electric motor driving force constraining conditions (for example, steps ST5, ST6, and ST7) are satisfied, and proceeds to the process of step ST9. In step ST8, it becomes possible to reduce the load of the electric motor 3, and also to prevent decrease of the drivability. Further, in the case where a state in which the constraining conditions are not satisfied during the creep driving constraining mode, the ECU 8 transits to the creep running mode and performs the driving control of the electric motor 3.

At step ST9, the ECU 8 determines whether or not the engine starting condition is satisfied. In detail, the ECU 8 determines whether or not a value indicating the driving force request (for example, an accelerator opening (AP)) is larger than a predetermined value. Specifically, the ECU 8 determines whether or not the required driving force is larger than the driving force of the electric motor 3 and requires driving force of the engine 2.

As a result of the determination, in the case where it is determined that the engine starting condition is satisfied, the ECU 8 proceeds to the process of step ST10, and returns to the process of step ST1 in cases other than that.

At step ST10, the ECU 8 performs the engine starting process.

For example, in the case where the vehicle speed is equal to or less than the creep speed, and also is equal to or larger than the engine starting-enabled speed, the electric motor 3 is equal to or less than the creep rotational speed and is equal to or more than the engine starting-enabled rotational speed. In the case of starting the engine 2 in such condition, the ECU 8 performs control so as to connect the engine 2 and the electric motor 3 with the first clutch C1. In the state where the engine 2 and the electric motor 3 are connected, the motive power from the electric motor 3 and the drive wheels 4 transmits to the engine 2, and the crank shaft of the engine 2 rotates at equal to or more than the engine starting-enabled rotational speed. The ECU 8 controls a fuel supply unit (not shown) to supply fuel to the engine 2, so that the engine 2 starts.

As is explained above, in the case where the vehicle speed is equal to or less than the creep speed, and also is equal to or more than the engine starting-enabled speed, because the creep speed is set higher than the engine starting-enabled speed by a predetermined speed, it becomes comparatively easy to start the engine 2, by connecting the first clutch C1 and performing the fuel supply to the engine 2.

Further, for example in the case where the vehicle speed is higher than the creep speed, when the first clutch C1 is connected, the motive power from the drive wheels 4 transmits to the engine 2, and the engine 2 becomes the engine starting-enabled rotational speed or a rotational speed more than that. Therefore, the engine 2 comparatively easily starts by performing the fuel supply to the engine 2 at this state.

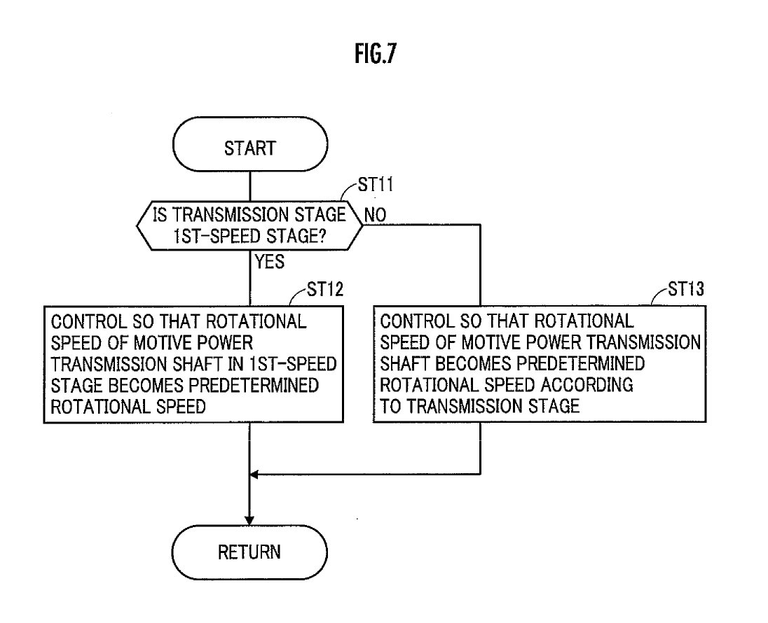

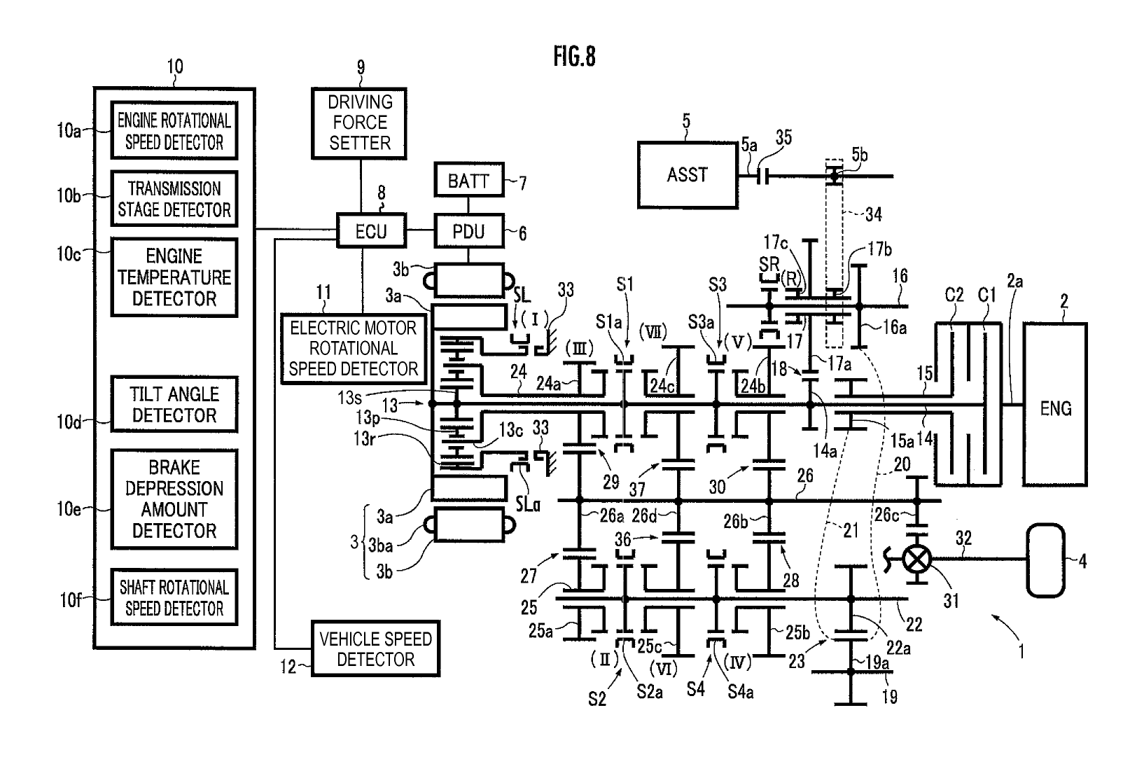

With reference to FIG. 7, explanation will be given on the operation of drive controlling of the electric motor 3, so that the speed of the vehicle becomes the target speed (the creep speed) during creep running of the hybrid vehicle of the present embodiment.

At step ST11, the ECU 8 determines, during creep running, whether or not the transmission stage is the 1st-speed stage. As a result of the determination, in the case where it is determined that the transmission stage is the 1st-speed stage, the ECU 8 proceeds to the process of step ST12, and in the case where the transmission stage is other than the 1st-speed stage, more specifically in the case where the transmission stage is the 2nd-speed stage to the 5th-speed stage, or the reverse stage, the ECU 8 proceeds to the process of step ST13.

At step ST12, the ECU 8 drive controls the electric motor 3, so that the rotational speed of the main shaft (the first main input shaft 14) as the motive power transmission shaft in the 1st-speed stage becomes a predetermine rotational speed (for example, 800 to 1000 rpm).

The rotational speed of the main shaft may be directly detected by the motive power transmission shaft rotational speed detector 10f provided with the motive power transmission device 1. Alternatively, the ECU 8 may specify the rotational speed of the main shaft by estimating the rotational speed thereof by calculation, on the basis of an operation parameter and the like of the electric motor 3. As the operation parameter of the electric motor 3, for example, the rotational speed Nm of the electric motor 3, the driving current and the driving voltage of the electric motor 3, the transmission ratio of the transmission stage selected by the motive power transmitting device 1, the vehicle speed, and the like, may be listed.

At step ST13, in the case where the transmission stage other than the 1st-speed stage is selected, the ECU 8 drive controls the electric motor 3 so that the rotational speed of the motive power transmission shaft (for example, the first main input shaft 14, the first sub input shaft 15, the second main input shaft 22, the output shaft 26, and the like) becomes a predetermined rotational speed. The rotational speed of the motive power transmission shaft may be directly detected by the motive power transmission shaft rotational speed detector 10f. Alternatively, the ECU 8 may estimate the rotational speed by calculation on the basis of the operation parameter and the like of the electric motor 3.

As is explained above, the hybrid vehicle of the present embodiment has the electric motor 3 and the engine 2 that are capable of transmitting motive power to the drive wheels 4 via the output shaft 26 (the motive power transmission shaft) of the motive power transmitting device 1, and is capable of starting the engine 2 by the electric motor 3. Further, the motive power transmitting device 1 has the first clutch C1 which is capable of connecting or disconnecting the engine 2 and the electric motor 3. Further, the hybrid vehicle has the ECU 8 which drive controls the electric motor 3 so that the creep speed which is the desired vehicle speed is achieved during creep running, in the state where the connection between the engine 2 and the electric motor 3 is disconnected by the first clutch C1 and the engine 2 is stopped. The ECU 8 sets the creep rotational speed of the electric motor 3 corresponding to the creep speed to become larger than the engine starting-enabled rotational speed of the engine 2 by a predetermined rotational speed.

Further, in the case where the starting condition of the engine 2 is satisfied when the rotational speed of the electric motor 3 is equal to or more than the starting-enabled rotational speed during the creep running, the ECU 8 connects the engine 2 and the electric motor 3 by the first clutch C1, and star controls the engine 2 at equal to or more than the starting-enabled rotational speed by the motive power of the electric motor 3.

That is, during the creep running, by connecting the engine 2 and the electric motor 3 at the rotational speed of the electric motor 3 equal to or more than the engine starting-enabled rotational speed, the engine 2 is made to be equal to or more than the engine starting-enabled rotational speed by the motive power of the electric motor 3, it becomes possible to start the engine 2 comparatively easily and surely, without performing troublesome operation.

Further, the motive power transmitting device 1 may be equipped with a plurality of transmission stages with different transmission ratios. Further, the hybrid vehicle may be equipped with the transmission stage detector 10b which detects the transmission stage selected by the motive power transmitting device 1, and the motive power transmission shaft rotational speed detector 10f which detects the rotational speed of the motive power transmission shaft (the first main input shaft 14) connectable by the engine 2 via the first clutch C1. In this case, the ECU 8 drive controls the electric motor 3, in the case where the transmission stage detected by the transmission stage detector 10b during creep running is the 1st-speed stage, so that the rotational speed of the motive power transmission shaft (the first main input shaft 14) connectable by the engine 2 via the first clutch C1 to become a predetermined rotational speed. That is, the ECU 8 drive controls the electric motor 3 so that the rotational speed of the motive power transmission shaft (the first main input shaft 14) to become a predetermined rotational speed during creep running, so that it is possible to control the vehicle comparatively easily to become the creep speed.

Further, the hybrid vehicle may be equipped with a temperature detector 10c for detecting the temperature of the engine 2. In this case, the ECU 8 defines the creep speed so that it becomes larger as the temperature detected by the temperature detector 10c becomes lower. That is, by defining the creep speed to become larger as the temperature detected by the temperature detector 10c, the ECU 8 is capable of starting the engine surely by the electric motor 3 even in the case where the temperature of the engine 2 is comparatively low.

Further, the ECU 8 may perform control of the electric motor 3 so as to constrain the driving of the electric motor 3, in the case where the vehicle speed continues for a predetermine time or more at a predetermined value or less during creep running.

That is, in the case where the vehicle speed continues for a predetermined time (for example, about 10 seconds) at a predetermined value or less (for example, in the vicinity of 0 km/h) during creep running, it becomes possible to reduce the load of the electric motor 3 by constraining the driving of the electric motor 3, for example to prevent the torque of the threshold value or more from continuing.

Further, the ECU 8 may perform control so as to constrain the driving of the electric motor 3 in the case where the rotational speed of the electric motor 3 is equal to or more than the creep rotational speed.

That is, in the case where the rotational speed of the electric motor 3 is equal to or more than the creep rotational speed during creep running, it becomes possible to prevent the vehicle speed from becoming equal to or more than the creep speed, and also to prevent the decrease in the efficiency of the electric motor 3, by constraining the driving of the electric motor 3.

Further, the hybrid vehicle may have the tilt angle detector 10d which detects the tilt angle of the vehicle, and the driving force setter 9 which sets the driving power request. At this time, the ECU 8 may perform control so as to constrain the driving of the electric motor 3, in the case where the vehicle is determined to be positioned at the downgrade on the basis of the determination result of the tilt angle detector 10d, and also the set value of the driving force request by the driving force setter 9 is equal to or smaller than a predetermined value.

That is, the ECU 8 determines that the driving power of the electric motor 3 is not required and constrains the driving of the electric motor 3, in the case where it is determined that the vehicle is positioned at the downgrade, and the set value of the driving force request by the driving force setter 9 is equal to or smaller than the predetermined value. Therefore, it becomes possible to decrease the load of the electric motor 3, and also prevent the vehicle from becoming comparatively high speed.

The explanation had been given on an embodiment, but the present invention is not limited to the above-explained embodiment.

Further, the structure of the ECU 8 is not limited to the manner explained above.

### Second Embodiment

Referring now to FIG. 8, a hybrid vehicle according to a second embodiment of the present invention will be described. A motive power transmitting device 1 of the second embodiment is constituted of transmission stages of seven forward stages and one reverse stage. This means that two transmission stages, namely, a 6th-speed stage and a 7th-speed stage, are added as the forward stages to the motive power transmitting device 1 of the first embodiment.

A 7th-speed gear train 37 is added to the motive power transmitting device 1 of FIG. 1 as an odd-numbered gear train that establishes an odd-numbered transmission stage in the transmission ratio rank. A 7th-speed gear 24c, which is a drive gear of the 7th-speed gear train 37, is rotatably supported between a 3rd-speed gear 24a and a 5th-speed gear 24b by a first main input shaft 14.

The first main input shaft 14 and a second auxiliary input shaft 24 are connected through the intermediary of a first synchronous engaging mechanism S1 and a third synchronous engaging mechanism S3, which are constituted of synchromesh mechanisms. The first synchronous engaging mechanism S1 and the third synchronous engaging mechanism S3 are provided on the first main input shaft 14. The first synchronous engaging mechanism S1 selectively connects the 3rd-speed gear 24a and the 7th-speed gear 24c to the first main input shaft 14, while the third synchronous engaging mechanism S3 selectively connects the 5th-speed gear 24b to the first main input shaft 14.

As with the motive power transmitting device 1 of FIG. 1, the first synchronous engaging mechanism S1 moves a sleeve S1a in the axial direction of the second auxiliary input shaft 24 by an actuator and a shift fork, not shown, thereby selectively connecting the 3rd-speed gear 24a and the 7th-speed gear 24c to the first main input shaft 14. More specifically, if the sleeve S1a is moved from the neutral position in the drawing toward the 3rd-speed gear 24a, then the 3rd-speed gear 24a and the first main input shaft 14 are connected. Meanwhile, if the sleeve S1a is moved from the neutral position in the drawing toward the 7th-speed gear 24c, then the 7th-speed gear 24c and the first main input shaft 14 are connected.

As with the first synchronous engaging mechanism S1, the third synchronous engaging mechanism S3 moves a sleeve S3a in the axial direction of the second auxiliary input shaft 24 by an actuator and a shift fork, not shown, thereby selectively connecting the 5th-speed gear 24b to the first main input shaft 14. More specifically, if the sleeve S3a is moved from the neutral position in the drawing toward the 5th-speed gear 24b, then the 5th-speed gear 24b and the first main input shaft 14 are connected.

Further, a 6th-speed gear train 36 is added to the motive power transmitting device 1 of FIG. 1 as an even-numbered gear train that establishes an even-numbered transmission stage in the transmission ratio rank. A 6th-speed gear 25c, which is a drive gear of the 6th-speed gear train 36, is rotatably supported between a 2nd-speed gear 25a and a 4th-speed gear 25b by a second main input shaft 22.

The second main input shaft 22 and a third auxiliary input shaft 25 are connected through the intermediary of a second synchronous engaging mechanism S2 and a fourth synchronous engaging mechanism S4, which are constituted of synchromesh mechanisms. The second synchronous engaging mechanism S2 and the fourth synchronous engaging mechanism S4 are provided on the second main input shaft 22. The second synchronous engaging mechanism S2 selectively connects the 2nd-speed gear 25a and the 6th-speed gear 25c to the second main input shaft 22, while the fourth synchronous engaging mechanism S4 selectively connects the 4th-speed gear 25b to the second main input shaft 22.

As with the motive power transmitting device 1 of FIG. 1, the second synchronous engaging mechanism S2 moves a sleeve S2a in the axial direction of a third auxiliary input shaft 25 by an actuator and a shift fork, not shown, thereby selectively connecting the 2nd-speed gear 25a and the 6th-speed gear 25c to the second main input shaft 22. More specifically, if the sleeve S2a is moved from the neutral position in the drawing toward the 2nd-speed gear 25a, then the 2nd-speed gear 25a and the second main input shaft 22 are connected. Meanwhile, if the sleeve S2a is moved from the neutral position in the drawing toward the 6th-speed gear 25c, then the 6th-speed gear 25c and the second main input shaft 22 are connected.

As with the first to the third synchronous engaging mechanisms S1 to S3, the fourth synchronous engaging mechanism S4 moves a sleeve S4a in the axial direction of the third auxiliary input shaft 25 by an actuator and a shift fork, not shown, thereby selectively connecting the 4th-speed gear 25b to the second main input shaft 22. More specifically, if the sleeve S4a is moved from the neutral position in the drawing toward the 4th-speed gear 25b, then the 4th-speed gear 25b and the second main input shaft 22 are connected.

The third auxiliary input shaft 25 and the output shaft 26 are connected through the intermediary of the 2nd-speed gear train 27, the 4th-speed gear train 28 and the 6th-speed gear train 36. The 2nd-speed gear train 27 is formed by the gear 25a fixed on the third auxiliary input shaft 25 and a gear 26a fixed on the output shaft 26, the gear 25a and the gear 26a meshing with each other. A 4th-speed gear train 28 is formed by a gear 25b fixed on the third auxiliary input shaft 25 and a gear 26b fixed on the output shaft 26, the gear 25b and the gear 26b meshing with each other. The 6th-speed gear train 36 is formed by the gear 25c fixed on the third auxiliary input shaft 25 and a gear 26d fixed on the output shaft 26, the gear 25c and the gear 26d meshing with each other.

Further, the second auxiliary input shaft 24 and the output shaft 26 are connected through the intermediary of the 3rd-speed gear train 29, a 5th-speed gear train 30 and a 7th-speed gear train 37. The 3rd-speed gear train 29 is constituted by the gear 24a fixed on the second auxiliary input shaft 24 and the gear 26a fixed on the output shaft 26, the gear 24a and the gear 26a meshing with each other. The 5th-speed gear train 30 is constituted by the gear 24b fixed on the second auxiliary input shaft 24 and the gear 26b fixed on the output shaft 26, the gear 24b and the gear 26b meshing with each other. The 7th-speed gear train 37 is constituted by the gear 24c fixed on the second auxiliary input shaft 24 and the gear 26d fixed on the output shaft 26, the gear 24c and the gear 26d meshing with each other.

The gear 26d, which is a driven gear in engagement with the 6th-speed gear 25c and the 7th-speed gear 24c, is secured on the output shaft 26 together with the gears 26a and 26b, which are driven gears, and a final gear 26c.

The rest of the construction is the same as that of the construction of the motive power transmitting device 1 of FIG. 1, so that the description thereof will be omitted.

A description will now be given of the operation of the motive power transmitting device 1 of the second embodiment constructed as described above. The 1st-speed stage to the 3rd-speed stage and the reverse stage are the same as those of the motive power transmitting device 1 of the first embodiment, so that the description thereof will be omitted.

The 4th-speed stage is established by setting a fourth synchronous engaging mechanism S4 in a state wherein the second main input shaft 22 and the 4th-speed gear 25b are connected. In the case of a travel on the engine 2, the second clutch C2 is set in an ON state. At the 4th-speed stage, the driving force output from the engine 2 is transmitted to drive wheels 4 through the intermediary of the first auxiliary input shaft 15, the gear train 21, the intermediate shaft 19, the gear train 23, the second input shaft 22, the 4th-speed gear train 28, and the output shaft 26, and the like.

In other words, the motive power transmitting device 1 of the second embodiment differs from the motive power transmitting device 1 of the first embodiment in that the 4th-speed gear 25b and the second main input shaft 22 are connected by the fourth synchronous engaging mechanism S4 rather than the second synchronous engaging mechanism S2 to establish the 4th-speed stage.

As with the motive power transmitting device 1 of the first embodiment, the assist travel, the EV travel and the deceleration regenerative drive can be accomplished also at the 4th-speed stage. Further, the same operation as with the motive power transmitting device 1 of the first embodiment is performed to implement a downshift or a pre-shift to the 3rd-speed stage or an upshift or a pre-shift to the 5th-speed stage while the vehicle is traveling at the 4th-speed stage. However, to implement the upshift or the pre-shift to the 5th-speed stage, the first main input shaft 14 and the 5th-speed gear 24b are set in a connected state or in a state close thereto by a third synchronous engaging mechanism S3.

The 5th-speed stage is established by setting the third synchronous engaging mechanism S3 in the state wherein the first main input shaft 14 and the 5th-speed gear 24b are connected. When the vehicle travels on the engine 2, a first clutch C1 is set to an ON state. At the 5th-speed stage, the driving force output from the engine 2 is transmitted to the drive wheels 4 through the intermediary of the first main input shaft 14, a 5th-speed gear train 30, and the output shaft 26.

In other words, the motive power transmitting device 1 of the second embodiment differs from the motive power transmitting device 1 of the first embodiment in that the 5th-speed gear 24b and the first main input shaft 14 are connected by the third synchronous engaging mechanism S3 rather than the first synchronous engaging mechanism S1 in order to establish the 5th-seed stage.

As with the motive power transmitting device 1 of the first embodiment, the assist travel, the EV travel and the deceleration regenerative drive can be accomplished also at the 5th-speed stage.

During the travel at the 5th-speed stage, an ECU 8 predicts, on the basis of the traveling condition of the vehicle, whether the next target transmission stage will be the 4th-speed stage or the 6th-speed stage. If the ECU 8 predicts a downshift to the 4th-speed stage, then the fourth synchronous engaging mechanism S4 is set to a state wherein the 4th-speed gear 25b and the second main input shaft 22 are connected or to a pre-shift state, which is close to the aforesaid state. If the ECU 8 predicts an upshift to the 6th-speed stage, then the second synchronous engaging mechanism S2 is set to a state wherein the 6th-speed gear 25c and the second main input shaft 22 are connected or to a pre-shift state, which is close to the aforesaid state. Thus, the upshift or downshift from the 5th-speed stage can be smoothly accomplished.

The 6th-speed stage is established by setting the second synchronous engaging mechanism S2 to a state wherein the second main input shaft 22 and the 6th-speed gear 25c are connected. For traveling on the engine 2, the second clutch C2 is set to the ON state. At the 6th-speed stage, the driving force output from the engine 2 is transmitted to the drive wheels 4 through the intermediary of the first auxiliary input shaft 15, the gear train 21, the intermediate shaft 19, the gear train 23, the second main input shaft 22, the 6th-speed gear train 36, and the output shaft 26.

With the second clutch C2 set to the ON state and the first clutch C1 set to the ON state, the assist travel by the electric motor 3 at the 6th-speed stage can be performed by driving the engine 2 and also driving the electric motor 3. Further, stopping the drive on the engine 2 in this state allows the EV travel to be performed.

During the travel at the 6th-speed stage, the ECU 8 predicts, on the basis of the traveling condition of the vehicle, whether the next target transmission stage will be the 5th-speed stage or the 7th-speed stage. If the ECU 8 predicts a downshift to the 5th-speed stage, then the third synchronous engaging mechanism S3 is set to a state wherein the first main input shaft 14 and the 5th-speed gear 24b are connected or to a pre-shift state, which is close to the aforesaid state. If the ECU 8 predicts an upshift to the 7th-speed stage, then the first synchronous engaging mechanism S1 is set to a state wherein the first main input shaft 14 and the 7th-speed gear 24c are connected or to a pre-shift state, which is close to the aforesaid state. Thus, the upshift or downshift from the 6th-speed stage can be smoothly accomplished.

The 7th-speed stage is established by setting the first synchronous engaging mechanism S1 to a state wherein the first main input shaft 14 and the 7th-speed gear 24c are connected. For traveling on the engine 2, the first clutch C1 is set to the ON state. At the 7th-speed stage, the driving force output from the engine 2 is transmitted to the drive wheels 4 through the intermediary of the first main input shaft 14, the 7th-speed gear train 37, and the output shaft 26.

With the first clutch C1 set to the ON state, the assist travel by the electric motor 3 at the 7th-speed stage can be performed by driving the engine 2 and also driving the electric motor 3. Further, setting the first clutch C1 to the OFF state allows the EV travel to be performed. During the EV travel, the first clutch C1 can be set to the ON state and the drive on the engine 2 can be stopped and the EV travel can be continued. Further, the deceleration regenerative drive can be accomplished at the 7th-speed stage.

While the vehicle is traveling at the 7th-speed stage, if the ECU 8 determines that the next target transmission stage will be the 6th-speed stage on the basis of the traveling condition of the vehicle, then the ECU 8 sets the second synchronous engaging mechanism S2 to a state wherein the 6th-speed gear 25c and the second main input shaft 22 are connected or a pre-shift state, which is close to the aforesaid state. This permits a smooth downshift from the 7th-speed stage to the 6th-speed stage.

As is explained above, even in the case where the motive power transmitting device 1 is constituted of transmission stages of seven forward stages and one reverse stage, a similar effect as that in the case whether the motive power transmitting device 1 is constituted as in the first embodiment.

Also, the motive power transmitting device 1 is not limited to the configuration shown in FIG. 1 and FIG. 8. For example, the transmission stage of the hybrid vehicle may have stepped transmission stages of 8 speeds or more.

### INDUSTRIAL APPLICABILITY

As is explained above, according to the hybrid vehicle of he present invention, it becomes possible to start the engine comparatively easily and surely by the electric motor during creep running, so that it is useful in improving the usability of the hybrid vehicle.

1. A hybrid vehicle comprising an electric motor and an internal combustion engine capable of transmitting motive power to a driven unit via a motive power transmission shaft of a motive power transmitting device, and which is capable of starting the internal combustion engine with the electric motor;
wherein the motive power transmitting device comprises a connecting-disconnecting device capable of connecting and disconnecting between the internal combustion engine and the electric motor; and
an engaging mechanism capable of connecting between the motive power transmission shaft and the driven unit;
the hybrid vehicle comprises a controller which drive controls the electric motor so that a creep speed which is a target vehicle speed is achieved during creep running, in the state where the connection between the internal combustion engine and the electric motor is disconnected by the connecting-disconnecting device and in the state where the internal combustion engine is stopped, by transmitting the motive power of the electric motor to the driven unit by connecting between the motive power transmission shaft and the driven unit with the engaging mechanism;
wherein the controller sets a creep rotational speed of the electric motor corresponding to the creep speed to be larger by a predetermined rotational speed than a starting-enabled rotational speed of the internal combustion engine, and start controls the internal combustion engine at equal to or more than the starting enabled rotational speed by a motive power of the electric motor, at the rotational speed of the electric motor at equal to or more than the starting enabled rotational speed during the creep running, and if a starting condition of the internal combustion engine is satisfied.

2. The hybrid vehicle according to claim 1,
wherein the motive power transmitting device is equipped with a plurality of transmission stages having different transmission ratios,
and the hybrid vehicle further comprises a transmission stage detector which detects the transmission stage selected by the motive power transmitting device, and
a shaft rotational speed detector which detects the rotational speed of the power transmission shaft which is connectable to the internal combustion engine via the connecting-disconnecting device,
wherein the controller drive controls the electric motor so that the rotational speed of the motive power transmitting shaft becomes a predetermined rotational speed, during creep running, in the case where the transmission stage detected by the transmission stage detector is a 1st-speed stage.

3. The hybrid vehicle according to claim 1,
further equipped with a temperature detector which detects a temperature of the internal combustion engine,
wherein the controller defines the creep speed to become larger, as the temperature detected by the temperature detector becomes lower.

4. The hybrid vehicle according to claim 1,
wherein the controller performs control so as to suppress the driving of the electric motor, in the case where the vehicle speed continues for a predetermined time or more at a predetermine speed or less during the creep running.

5. The hybrid vehicle according to claim 2,
wherein the controller performs control so as to suppress the driving of the electric motor, in the case where the vehicle speed continues for a predetermined time or more at a predetermine speed or less during the creep running.

6. The hybrid vehicle according to claim 3,
wherein the controller performs control so as to suppress the driving of the electric motor, in the case where the vehicle speed continues for a predetermined time or more at a predetermine speed or less during the creep running.

7. The hybrid vehicle according to claim 1,
further comprising a tilt angle detector which detects a tilt angle of the vehicle, and
a driving force setter which sets a driving force request,
wherein the controller performs control so as to suppress the driving of the electric motor, in the case where it is determined that the vehicle is positioned at a downgrade, and that a set value by the driving force request by the driving force setter is equal to or less than a predetermined value.

8. The hybrid vehicle according to claim 1,
wherein the controller performs control so as to suppress the driving of the electric motor, in the case where the rotational speed of the electric motor is equal to or more than the creep rotational speed.

9. The hybrid vehicle according to claim 2,
wherein the controller performs control so as to suppress the driving of the electric motor, in the case where the rotational speed of the electric motor is equal to or more than the creep rotational speed.

10. The hybrid vehicle according to claim 3,
wherein the controller performs control so as to suppress the driving of the electric motor, in the case where the rotational speed of the electric motor is equal to or more than the creep rotational speed.

11. The hybrid vehicle according to claim 4,
wherein the controller performs control so as to suppress the driving of the electric motor, in the case where the rotational speed of the electric motor is equal to or more than the creep rotational speed.

12. The hybrid vehicle according to claim 5,
wherein the controller performs control so as to suppress the driving of the electric motor, in the case where the rotational speed of the electric motor is equal to or more than the creep rotational speed.

13. The hybrid vehicle according to claim 6,
wherein the controller performs control so as to suppress the driving of the electric motor, in the case where the rotational speed of the electric motor is equal to or more than the creep rotational speed.

14. The hybrid vehicle according to claim 7,
wherein the controller performs control so as to suppress the driving of the electric motor, in the case where the rotational speed of the electric motor is equal to or more than the creep rotational speed.
